(19) United States
(12) Patent Application Publication
(10) Pub. No.: US 2012/0263560 A1
(43) Pub. Date: Oct. 18, 2012

(54) SYSTEM AND METHOD FOR CONTROLLING CROP TRANSFER

(76) Inventors: Norbert Diekhans, Guetersloh (DE); Jochen Huster, Guetersloh (DE); Frank Claussen, Harsewinkel (DE)

(21) Appl. No.: 13/417,495

(22) Filed: Mar. 12, 2012

(30) Foreign Application Priority Data
Apr. 15, 2011 (DE) 10 2011 002 071.3

(51) Int. Cl. B65G 67/22

(52) U.S. Cl. 414/294

(57) ABSTRACT

A system for controlling crop transfer from a self-propelled agricultural harvesting machine into the loading container of a hauling vehicle includes a transfer device assigned to the harvesting machine from which the crop emerges in the form of a crop discharge flow and a detection device which detects the position of the loading container relative to the harvesting machine and transmits it to a control unit. The control unit actuates at least one actuator assigned to the transfer device in such a way that the crop discharge flow lands within the loading container in order to fill it with crop. The control unit generates a control signal (S) for the hauling vehicle that specifies a position of the hauling vehicle relative to the harvesting machine that is suitable for transfer into the loading container.

### CROSS-REFERENCE TO A RELATED APPLICATION

The invention described and claimed hereinbelow is also described in German Patent Application DE 10 2011 002 071.3, filed on Apr. 15, 2011. The German Patent Application, whose subject matter is incorporated by reference herein, provides the basis for a claim of priority of invention under 35 U.S.C. 119(a)-(d).

### BACKGROUND OF THE INVENTION

The invention relates to a system for controlling crop transfer from a self-propelled agricultural harvesting machine into a loading container of a hauling vehicle, comprising a transfer device assigned to the harvesting machine, from which the crop emerges in the form of a crop discharge flow, and a detection device which ascertains a position of the loading container relative to the harvesting machine and transfers the position to a control unit, wherein the control unit actuates at least one actuator assigned to the transfer device in such a way that the crop discharge flow lands within the loading container in order to fill the loading container with crop.

Self-propelled agricultural harvesting machines such as forage harvesters are equipped with a transfer device which is referred to as an upper discharge chute due to the function and shape thereof. The transfer device serves to transfer crop that has been harvested during the harvesting operation and has passed through the inner processing and conveyor assemblies (intake rollers, chopper drums, corn crackers, post-accelerators) of the forage harvester to an accompanying loading container in the form of a crop discharge flow. The loading container can be located on a trailer drawn by a hauling vehicle (e.g. a tractor), or it can be part of a self-propelled hauling vehicle (e.g. a truck).

Since the forage harvester and the hauling vehicle move across the field during the transfer procedure at a ground speed that is not inconsiderable and because it is practically impossible for the forage harvester and the hauling vehicle to travel in parallel due simply to uneven terrain (which frequently causes the travelling machinery to deviate from the tracks thereof), in order to ensure that the crop is transferred without losses, it must be possible to orient the transfer bend differently by way of a plurality of actuators in order to thereby steer the emerging crop discharge flow such that it lands within the loading container. Such actuators usually comprise a rotary drive of the transfer bend about a vertical—with respect to the forage harvester—axis, a height adjustment of the transfer bend about a horizontal—with respect to the forage harvester—axis, and a discharge angle adjustment implemented by way of an adjustable flap on the discharge-side end of the upper discharge chute.

Due to increasing rates of crop throughput on forage harvesters, the requirements on the transfer procedure increase continually since a loading container having the same volume fills in an increasingly shorter period of time due to the higher throughput performance. Precise orientation of the crop discharge flow is an essential prerequisite for attaining this. Due to high ground speeds on the field, manual orientation of the transfer device requires much effort on the part of the driver of a forage harvester.

Document EP 2 020 174 A1 describes a system for the automatic control of the crop transfer, in which the transfer procedure is recorded using a camera and the captured images are evaluated. In the evaluation, the position of the loading container relative to the harvesting machine is determined. On the basis thereof, a control device initiates an appropriate orientation of the upper discharge chute, thereby making automatic transfer possible.

A prerequisite for the system according to EP 2 020 174 A1, however, is that the loading container must be located within a certain range of position relative to the harvesting machine since, otherwise, the upper discharge chute impacts the end positions thereof when oriented by the actuators, thereby disabling the control system. In addition, the system does not account for the fact that the position of the loading container relative to the harvesting machine that is optimal for the transfer procedure—depending on the filling state of the loading container, for example—can change entirely during the filling procedure. To compensate for these two limitations of the system, the drivers of the machines must intervene in the control and steering in a suitable manner, which requires much finesse and experience.

### SUMMARY OF THE INVENTION

The present invention provides improvements to known prior art systems, at least some of which overcome the above-mentioned shortcomings.

In one embodiment, the invention provides a system and method for the automatic control of the crop transfer, which provide the drivers of a hauling vehicle and a harvesting machine with greater relief from observing the transfer procedure. Furthermore, a corresponding method will be provided.

In the inventive system, a control unit, which controls the actuators of the transfer device and, therefore, the orientation of the crop discharge flow, can be operated to generate a control signal for the hauling vehicle that specifies a position of the hauling vehicle relative to the harvesting machine that is suitable for transfer into the loading container. System operation is based on the finding that two processes must interact dynamically in a suitable manner to ensure loss-free, automatic control of the procedure for filling the loading container. The first of the two processes is the orientation of the crop discharge flow which can be influenced quickly by actuating the actuators of the transfer device.

Simultaneously, the loading container must be located in a suitable position relative to the harvesting machine, i.e., the second process. This second process has a much longer reaction time compared to the orientation of the crop discharge flow. Since the control unit—which directs the crop discharge flow within the design-related boundaries of the loading container by orienting the transfer device—also generates a control signal directed to the hauling vehicle that specifies a relative position of the hauling vehicle that is suitable for transfer into the loading container, the inventive system advantageously provides the drivers of the hauling vehicle and the harvesting machine with greater relief from observing the transfer procedure and links the two processes to each other in a favorable manner to prevent transfer losses and relieve the driver.

In an embodiment, the control signal can be output in a form that can be perceived by a driver of the hauling vehicle. For example, a control instruction could be output in a display that is visible to the driver of the hauling vehicle. The output could also be delivered acoustically by way of a loudspeaker. This could be a ground speed requirement and/or a direction-of-steering indicator. Such a signal output to the driver offers the advantage that the driver receives supportive, precise driving instructions—while allowing him to freely decide whether—or to what extent—to follow this instruction.

To increase comfort and relieve the driver further, the control signal is preferably input into a ground speed regulator assigned to the hauling vehicle, which automatically positions the hauling vehicle relative to the harvesting machine. By way of this measure, the ground speed of the hauling vehicle is controlled in a manner that is adapted to the transfer procedure and is partially autonomous or fully autonomous, depending on the extent of implementation, with the result that the self-propelled harvesting machine, as the leading vehicle, also controls the hauling vehicle.

The control signal can include a ground speed to be reached by the hauling vehicle and/or a rear wheel position to be implemented by the hauling vehicle.

In an embodiment, the control unit counteracts the transfer procedure approaching a critical state by way of a suitable control signal to the hauling vehicle. By way of this measure it can be ensured, for example, that, during crop transfer, the transfer device reaching an end position is counteracted, the loading container reaching an outer limit is counteracted, and/or a maximum fill level being reached is counteracted by adapting the relative position of the loading container to the changed transfer condition. Such an adaptation of the relative position is preferably implemented by the control unit in a timely manner, i.e. proactively, namely before the critical state is reached, thereby enabling the transfer procedure to continue without loss or interruption.

Appropriate sensors are required for detecting the particular critical state. They can be displacement or angular-position sensors assigned to the transfer device in the case of detecting the transfer device reaching end positions. Before an end position—which is detected by the sensors—is reached, the control unit initiates a change in relative position of the hauling vehicle to ensure that the transfer procedure is not endangered by the upcoming end position being reached.

In another embodiment, the invention provides a sensor, preferably in the form of a suitably oriented camera, which is suitable for detecting an impact point of the crop discharge flow, wherein the critical state is that the impact point is located outside of the loading container. According to this embodiment, the control unit detects whether the crop discharge flow is likely to leave the loading container and proactively initiates a change in the relative position of the hauling vehicle.

To determine whether the impact point is located outside of or inside the loading container, it is advantageous to provide a sensor which is suitable for detecting outer edges of the loading container. The control unit can thereby compare the position of the impact point and the outer edge to evaluate whether or where the crop discharge flow impacts the container. Advantageously, this sensor can likewise be a camera. Preferably it is the same camera that also detects the impact point.

In addition, or alternatively, the sensor is suitable for detecting the fill level of the loading container, wherein the critical state is a maximum fill level having been reached. Particularly advantageously, such a sensor can differentiate between various position-dependent filling states on the loading container. If the sensor is a camera, a position-dependent differentiation of filling state can be carried out by way of related image evaluation. Therefore, when a maximum fill level has been reached at one position of the loading container, the control unit can continue filling the loading container at another position by initiating a change in the relative position of the hauling vehicle.

Also, the control unit considers or implements a filling strategy, which is preferably selectable by the machine operator, when generating the control signal directed to the hauling vehicle. A filling strategy can be, for example, to fill the loading container from front to back (or vice versa).

The transfer device can basically be a device having any design, which is suitable for delivering a crop discharge flow. Highly diverse actuators can therefore be used to orient the crop discharge flow. In the case, in particular, of an upper discharge chute which is typical for forage harvesters, the at least one actuator assigned to the upper discharge chute is an actuator for adjusting the height of the transfer device, an actuator for rotating the transfer device, and an actuator for controlling the flap of the transfer device. In addition, an actuator for adjusting the gap width on the post-accelerator and/or any other type of actuator which is appropriate for the design and influences the impact point can be considered.

Various devices are feasible for use as a detection device for ascertaining the position of the loading container relative to the harvesting machine. The detection device preferably comprises an optical sensor, in the form of a camera, for example. Such a camera can be disposed on the harvesting machine, for example, in particular on the transfer device, and can be oriented such that it optically detects the loading container at least in regions. Electronic image evaluation is then used to determine the relative position, wherein the position of the transfer device is considered when the camera is mounted on the (movable) transfer device. Other mounting options for cameras for determining the relative position are feasible. For example, as an alternative or in addition, a camera could be disposed on the hauling vehicle or the loading container, which optically detects one or more reference points on the harvesting machine. A related image evaluation can then be carried out to determine the relative position of the loading container.

The use of a system comprising a plurality of cameras which capture different perspectives can increase the overall accuracy of the image evaluation and, therefore, the determination of relative position. Advantageously, a 3-D camera or a profile of a laser scanner is used.

Alternatively, or additionally, the inventive system includes and uses a detection device that is suitable for detecting the relative position of the loading container by comparing data on the position of the harvesting machine with data on the position of the loading container or the hauling vehicle. To this end, the harvesting machine and hauling vehicle or loading container can be equipped with navigation units which exchange their positions wirelessly.

The system according to the invention is suitable for controlling the crop transfer of self-propelled harvesting machines and is preferably included and operational in a forage harvester or a combine harvester.

For example, the invention includes a system for controlling crop transfer from a self-propelled agricultural harvesting machine (1) into the loading container (2) of a hauling vehicle (3) having a transfer device (4) assigned to the harvesting machine (1), from which the crop emerges in the form of a crop discharge flow (5) and a detection device which ascertains the position of the loading container (2) relative to the harvesting machine (1) and transmits it to a control unit (7). The control unit (7) actuates at least one actuator (8, 9, 10) assigned to the transfer device (4) in such a way that the crop discharge flow (5) lands within the loading container (2) in order to fill it with crop. The control unit (7) can be furthermore operated to generate a control signal (S) for the hauling vehicle (3) that specifies a position of the hauling vehicle (3) relative to the harvesting machine (1) that is suitable for transfer into the loading container (2).

The invention includes a method for controlling crop transfer from a self-propelled agricultural harvesting machine (1) into the loading container (2) of a hauling vehicle (3) using a transfer device (4) from which the crop emerges in the form of a crop discharge flow (5). The position of the loading container (2) relative to the harvesting machine (1) is determined in order to orient the transfer device (4) by way of at least one actuator (8, 9, 10) in such a way that the crop discharge flow (5) lands within the loading container (2). The hauling vehicle (3) is controlled into a position relative to the harvesting machine (1) that is suitable for transfer into the loading container (2).

### BRIEF DESCRIPTION OF THE DRAWING FIGURES

The present invention can best be understood in connection with the accompanying drawings. It is noted that the invention is not limited to the precise embodiments shown in drawings, in which:

FIG. 1 a schematic rear view of a forage harvester during lateral transfer of crop into a loading container; and

FIG. 2 a schematic top view of the subject matter depicted in FIG. 1.

### DETAILED DESCRIPTION OF PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

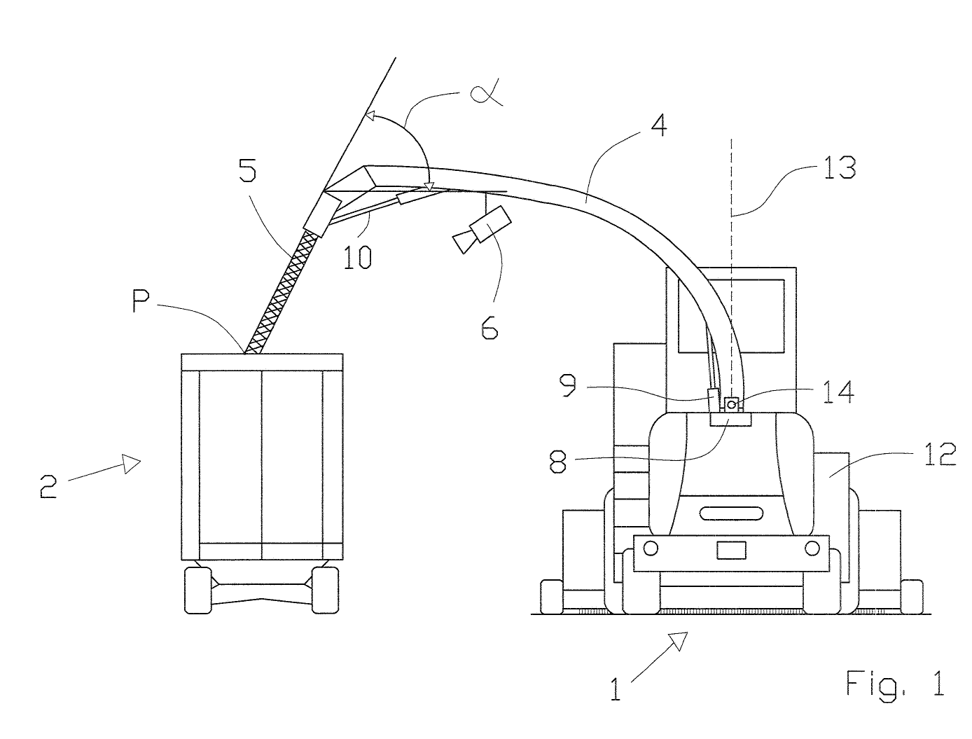

FIG. 1 shows, in a schematic view from the rear, a self-propelled forage harvester 1, which hurls (transfers) harvested and processed crop by way of an upper discharge chute 4 in the form of a crop discharge flow into a loading container 2 located next to the forage harvester 1. The loading container 2 is mounted on a driveable frame and is drawn parallel to the direction of travel of the forage harvester 1 by a hauling vehicle which is hidden by the loading container 2 in this view. The crop discharge flow 5 impacts the loading container 2 at an impact point P which is located within the outer walls of the loading container 2, thereby enabling crop to be transferred without loss.

In order to influence or control the position of the impact point P on the loading container 2, inter alia, the upper discharge chute 4 can be swiveled about a vertical axis 13 relative to the machine frame 12 of the forage harvester 1 by way of a rotary drive 8, and can be swiveled vertically about a horizontal axis 14 relative to the machine frame 12 of the forage harvester 1 by way of a lifting cylinder 9. Furthermore, a flap adjustment cylinder 10 is used to adjust the discharge angle a of the crop discharge flow 5 out of the upper discharge chute 4.

A camera 6 is mounted on the upper discharge chute 4, which is oriented to optically detect the loading container 2 including the impact point P.

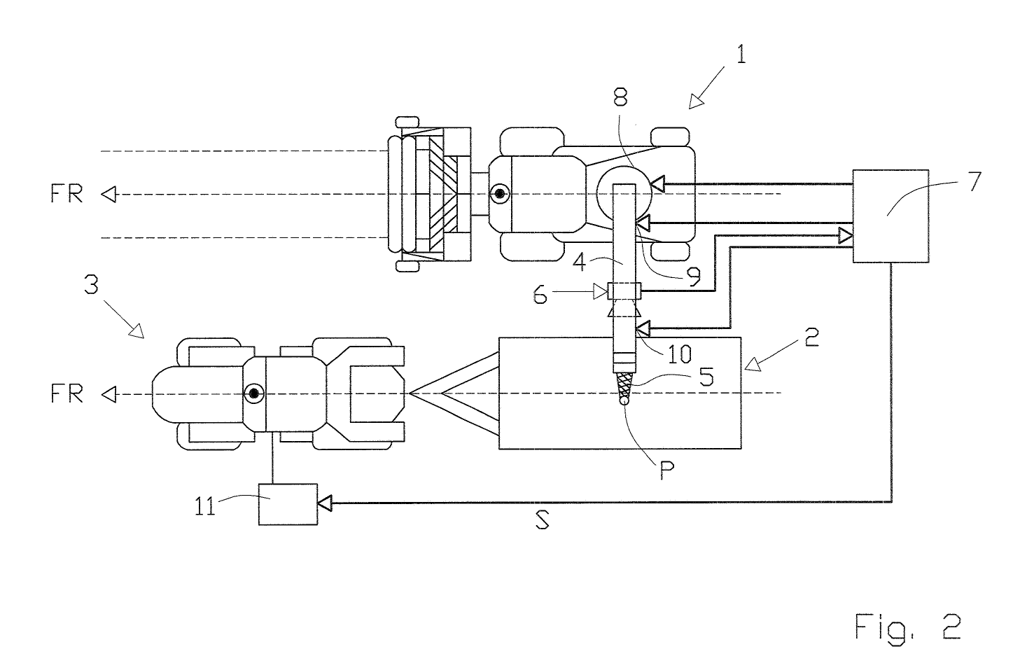

The modes of operation, including the effects achieved, are explained in the following with reference to FIG. 2, which shows the subject matter of FIG. 1 in a top view. The forage harvester 1 shown in FIG. 2 and the loading container 2 drawn by the hauling vehicle 3 comprises at least some of the features mentioned with reference to FIG. 1. Reference is made to the descriptions provided with respect thereto, to avoid repetition.

In addition to the depiction according to FIG. 1, FIG. 2 shows the hauling vehicle 3, a control unit, a regulator and schematic signal lines in order to explain the function and mode of operation of a system or method according to the invention for controlling crop transfer.

According to FIG. 2, the forage harvester 1 and the hauling vehicle 3, which is a tractor in this case, to which the loading container 2 (which is located on a chassis) is attached, move in the direction of travel FR at approximately the same ground speed. The camera 6 disposed on the upper discharge chute 4 optically detects the loading container 2 (see FIG. 1) and determines, on the basis of an image evaluation (e.g. by detecting the outer edges of the loading container 2) and with consideration for the position of the upper discharge chute 4, the position of the loading container 2 relative to the forage harvester 1. The determined information is transmitted to a control unit 7.

The control unit 7 is connected to the actuators 8, 9, 10 and controls them with consideration for the relative position that was determined in such a way that the crop discharge flow 7 strikes the impact point P within the loading container 2 in order to fill it with crop.

During filling, the camera 6 observes the relative position of the loading container 2 and the filling state thereof. If a maximum fill level is reached in one section of the loading container 2, the control unit 7 automatically initiates swiveling of the upper discharge chute 4 in order to fill another section of the loading container 2. To this end, one or more of the actuators 8, 9, 10, are actuated by the control unit 7. With respect to the filling procedure, the control unit 7 can advantageously consider a filling strategy which is selectable by the operator of the forage harvester 1. For example, a filling strategy could require that the loading container 2 be filled from front to back. Any other strategies are feasible, depending on the particular circumstances (e.g. container size/shape, edge height, filling state, transfer distance, etc.).

The transfer, which is described in this manner, can be carried out in a reliable manner only if the loading container 2 is located in a position relative to the forage harvester 1 that lies within the range of the upper discharge chute 4. If the loading container 2 leaves this range, for example, if the tractor 3 travels too rapidly or slowly, the impact point P will be located outside of the loading container boundaries and high crop losses will result. The same happens, for example, when implementing a filling strategy (feasible: “load from front to back”), if the upper discharge chute 4 reaches an end position and the impact point P therefore cannot be displaced further in the required direction.

The inventive system and method solve this problem in that the control unit 7, in addition to actuating the transfer device 4, generates a control signal S directed to the hauling vehicle 3. Control signal S specifies a position of the hauling vehicle 3 relative to the harvesting machine 1 that is suitable for transfer into the loading container 2. In the embodiment shown in FIG. 2, the control unit 7 therefore transmits a control signal S to a ground speed regulator 11 assigned to the hauling vehicle 3, wirelessly, for example. Please note that the line sketched in FIG. 2 between the control unit 7 and the ground speed regulator 11 therefore does not represent a line but rather a flow of information). The ground speed regulator 11 responds and automatically positions the hauling vehicle 3 relative to the harvesting machine 1. The ground speed regulator 11 achieves this by actively intervening in the ground speed and/or rear wheel position of the hauling vehicle 3.

In the embodiment shown, the position of the loading container 2 relative to the harvesting machine is determined solely by evaluating the optically detected camera image of the camera 6. Alternatively or in addition thereto, a different technical principle for determining the relative position is feasible. For example, the harvesting machine 1 and the hauling vehicle 3 and/or the loading container 2 could be equipped with position sensors (e.g. GPS navigation units) which are not shown. The relative position of the loading container would then be determined by comparing the particular position data, which would be transmitted from vehicle to vehicle wirelessly, for example, and transmitting the relative position that was determined to the control unit 7. It would also be feasible to compare optically determined position information with position information obtained using such position sensors, in order to increase the accuracy of the position determination.

As a result, in the system or method described, the relatively quickly reacting regulator of the upper discharge chute 4 is superposed by the relatively slowly reacting regulator of the relative positioning of the hauling vehicle, with the advantageous effect that the control unit 7 can counteract the transfer procedure approaching a critical state by way of a suitable control signal A to the hauling vehicle 3.

The following list of identifiers of various elements and references is included (as follows), for ease of explanation:

1 Forage harvester

2 Loading container

3 Hauling vehicle

4 Upper discharge chute

5 Crop discharge flow

6 Camera

7 Control unit

8 Rotary drive—chute

9 Lifting cylinder—chute

10 Flap adjustment cylinder

11 Ground speed regulator

12 Machine frame

13 Vertical pivot axis

14 Horizontal pivot axis

P Impact point

S Control signal

FR Direction of travel

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A system for controlling crop transfer from a self-propelled agricultural harvesting machine (1) into a loading container (2) of a hauling vehicle (3), comprising:
a transfer device (4) assigned to the harvesting machine (1), from which the crop emerges in the form of a crop discharge flow (5), and
a detection device which ascertains the position of the loading container (2) relative to the harvesting machine (1) and transmits it to a control unit (7),
wherein the control unit (7) actuates at least one actuator (8, 9, 10) assigned to the transfer device (4) in such a way that the crop discharge flow (5) lands within the loading container (2) in order to fill the loading container (2) with crop, and
wherein the control unit (7) operates to generate a control signal (S) for the hauling vehicle (3) that specifies a position of the hauling vehicle (3) relative to the harvesting machine (1), which position is suitable for transfer into the loading container (2).

2. The system according to claim 1, wherein the control signal (S) is output in a form that is understandable by a driver of the hauling vehicle (3).

3. The system according to claim 1, wherein the control signal (S) is input into a ground speed regulator (11) assigned to the hauling vehicle, which automatically positions the hauling vehicle (3) relative to the harvesting machine (1).

4. The system according to claim 1, wherein the control signal (S) includes a ground speed to be attained by the hauling vehicle (3), a rear wheel position to be implemented by the hauling vehicle (3), or both.

5. The system according to claim 1, wherein the control unit (7) counteracts the transfer procedure approaching a critical state by way of the control signal (S) generated for the hauling vehicle (3).

6. The system according to claim 5, wherein a sensor (6) is provided that is suitable for detecting an impact point (P) of the crop discharge flow (5) and wherein the critical state is the impact point (P) being located outside of the loading container (2).

7. The system according to claim 1, wherein a sensor (6) is provided that is suitable for detecting outer edges of the loading container (2).

8. The system according to claim 5, wherein a sensor (6) is provided that is suitable for detecting the filling state of the loading container (2) and wherein the critical state is a maximum fill level having been reached.

9. The system according to claim 5, wherein the critical state is an end position of the transfer device (4) having been reached.

10. The system according to claim 1, wherein the control unit (7) operates in accordance with a pre-specified or pre-configured filling strategy when generating the control signal (S).

11. The system according to claim 1, wherein the at least one actuator (8, 9, 10) is one or more of a group consisting of an actuator (9) for height adjustment of the transfer device (4), an actuator (8) for rotating the transfer device (4), an actuator (10) for the flap control of the transfer device (4), an actuator for the gap width adjustment on the post-accelerator and an actuator which influences the impact point (P).

12. The system according to claim 1, wherein the detection device comprises a camera (6) or a system comprising a plurality of cameras.

13. The system according to claim 12, wherein the camera (6) is disposed on the harvesting machine (1) and is oriented for the optical detection of the loading container (2).

14. The according to claim 1, wherein the detection device is configured to determine a relative position of the loading container (2) by comparing position data on the harvesting machine (1) with position data on the loading container (2) or the hauling vehicle (3).

15. The system according to claim 1, wherein the harvesting machine is a forage harvester (1) or a combine harvester.

16. A method for controlling crop transfer from a self-propelled agricultural harvesting machine (1) into the loading container (2) of a hauling vehicle (3) using a transfer device (4) from which the crop emerges in the form of a crop discharge flow (5), comprising:
determining a position of the loading container (2) relative to the harvesting machine (1) in order to orient the transfer device (4) by way of at least one actuator (8, 9, 10) in such a way that the crop discharge flow (5) lands within the loading container (2), and
controlling the hauling vehicle (3) into the position relative to the harvesting machine (1).
